(19) United States
(12) Patent Application Publication
(10) Pub. No.: US 2007/0085465 A1
(43) Pub. Date: Apr. 19, 2007

(54) Color cathode-ray tube

(75) Inventors: Hiroshi Sakurai, Takatsuki-shi (JP); Shinichi Arita, Ibaraki-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/513,088

(22) Filed: Aug. 30, 2006

(30) Foreign Application Priority Data
Oct. 13, 2005 (JP) 2005-299080

(51) Int. Cl. H01J 29/86; H01J 29/92

(52) U.S. Cl. 313/477 R

(57) ABSTRACT

A shadow mask includes a perforated region in which a plurality of electron beam passage apertures are formed, a non-perforated region on the periphery of the perforated region, and a skirt portion bent to an electron gun side with respect to the non-perforated region. The curved surfaces on an x-axis and a y-axis of the perforated region are convex to a panel side. The perforated region includes a curved surface that is convex to the panel side and a curved surface that is convex to the electron gun side on a periphery of the perforated region. Furthermore, the perforated region has a curved surface that is convex to the panel side and a curved surface that is convex to the electron gun side in a region surrounded by the periphery, the x-axis, and the y-axis. Because of this, the color displacement caused by doming can be reduced while a shadow mask is used which is made of an inexpensive iron material, and in which the increase in the difference in elevation in the z-axis direction between a center portion and a diagonal portion of the perforated region is suppressed.

### BACKGROUND OF THE INVENTION

1. Field of the Invention

The present invention relates to a color cathode-ray tube having a shadow mask.

2. Description of Related Art

FIG. 12 is a cross-sectional view showing a schematic configuration of a general color cathode-ray tube. The color cathode-ray tube includes an envelope 3 in which a panel 1 and a funnel 2 are connected to each other. On an inner surface of the panel 1, a phosphor screen 9 is formed, which is coated with phosphors of respective colors of red, green, and blue in a stripe shape or a dot shape. A shadow mask 10 is held by a frame 8 attached to an inner wall surface of the panel 1 so as to be opposed to the phosphor screen 9. A neck 2a of the funnel 2 houses an electron gun 4 emitting three electron beams 5 corresponding to the respective colors of red, green, and blue. A magnetic shield 7 shielding the electron beams 5 from an external magnetic field is attached to the frame 8. A deflection yoke 6 is mounted on an outer circumferential surface of the funnel 2 of the color cathode-ray tube as described above, whereby a color cathode-ray tube apparatus is configured. The three electron beams 5 emitted from the electron gun 4 are deflected in horizontal and vertical directions by the deflection yoke 6, pass through an internal space of the magnetic shield 7 and electron beam passage apertures formed on the shadow mask 10 successively, and strike the phosphors of the respective colors of the phosphor screen 9 to allow them to emit light. Thus, a color image is displayed in a useful display region of the panel 1.

FIG. 13 is a schematic perspective view of a shadow mask structure composed of the shadow mask 10 and the frame 8 in a substantially rectangular frame shape holding the shadow mask 10. The substantially rectangular shadow mask 10 is composed of a thin metal plate, and includes a perforated region 11 in a substantially rectangular shape in which a number of slot-shaped or dot-shaped electron beam passage apertures 21 are provided, a non-perforated region 12 placed on an outer periphery of the perforated region 11, and a skirt portion (not shown) bent with respect to the non-perforated region 12. An outer surface of the skirt portion and an inner wall surface of the frame 8 are overlapped with each other, whereby the skirt portion and the frame 8 are welded to each other. For convenience of the description, as shown, it is assumed that a center of the shadow mask 10 is an origin, a long-side direction axis of the shadow mask 10 is an x-axis, a short-side direction axis thereof is a y-axis, a normal to the shadow mask 10 at the origin (i.e., a tube axis of the cathode-ray tube) is a z-axis, and the direction directed from the shadow mask 10 to the electron gun 4 is the positive direction of the z-axis.

The shadow mask 10 has a plurality of tie-bands 15 with a longitudinal direction thereof being the y-axis direction, and a plurality of bridges connecting the tie-bands 15 adjacent to each other in the x-axis direction in the perforated region 11, and a plurality of electron beam passage apertures 21 are formed between the tie-bands 15 adjacent to each other in the x-axis direction.

By the time the electron beams 5 emitted from the electron gun 4 strike the phosphor screen 9, about 80% of the electron beams 5 strike the shadow mask 10, and the kinetic energy of the electrons is converted to heat energy, whereby the shadow mask 10 is heated. Thus, the shadow mask 10 thermally expands wholly or locally in accordance with the irradiation state of the electron beams 5. Hereinafter, these phenomena respectively are classified into “overall doming” and “local doming”, both of which will be collectively referred to as “doming”. Because of the thermal expansion of the shadow mask 10, the relative position of the electron beam passage apertures 21 with respect to the phosphors of the respective colors of the phosphor screen 9 changes. Therefore, the three electron beams 5 do not strike the corresponding phosphors correctly, which causes so-called color displacement.

In order to prevent such color displacement, there are two solutions: (A) the cause of the occurrence of doming is reduced and (B) the influence of doming is reduced. Regarding (A), the following means generally are used: (A1) the thermal expansion coefficient of the shadow mask 10 is decreased (e.g., see JP 59(1984)-127345 A) and (A2) an electron reflective layer is provided on a plane of the shadow mask 10 opposed to the electron gun 5, whereby the influence of the electron beams 5 is reduced (e.g., see JP 59(1984)-94325 A). Regarding (B), the following means generally is used: (B1) the curvature of the shadow mask 10 is increased (e.g., see JP 54(1979)-49062 A). The displacement in the z-axis direction of the shadow mask 10 has the largest influence on the color displacement. However, if the curvature of the shadow mask 10 is large, even when the shadow mask 10 expands thermally, the displacement amount in the z-axis direction may be relatively small, compared with the case where the curvature of the shadow mask 10 is small (i.e., flat), so that the color displacement can be suppressed to be small.

According to the above-mentioned means (A1), for example, if an Invar material that is a low expansion material is used as a material for the shadow mask 10 in place of iron (Fe), the thermal expansion coefficient becomes about 1/10. However, this suffers from a problem of expensiveness even though the effect is high.

According to the above-mentioned means (A2), although the effect of reducing doming by 20% to 30% can be obtained, for example, by coating the shadow mask 10 with bismuth oxide, the effect still is not sufficient.

According to the above-mentioned means (B1), the effect of reducing doming increases steadily along with the increase in the curvature of the shadow mask 10. However, when the curvature of the shadow mask 10 is increased, the difference in elevation in the z-axis direction between the center portion and the diagonal portion of the perforated region 11 of the shadow mask 10 increases. Therefore, it is necessary to increase the curvature of the phosphor screen 9 in accordance with the increase in the curvature of the shadow mask 10, thereby increasing the difference in elevation in the z-axis direction between the center portion and the diagonal portion of the phosphor screen 9. On the other hand, it is preferable for a commercial product that the outer surface of the panel 1 be flat. Therefore, when the difference in elevation in the z-axis direction between the center portion and the diagonal portion of the phosphor screen 9 increases, the difference in thickness between the center portion and the diagonal portion of the panel 1 increases. The light transmittance changes in proportion to the thickness of the panel 1. Therefore, there arises a problem that an image is lighter at the center portion and darker at the diagonal portion. Consequently, according to the means (B1), when an attempt is made to keep the brightness of an image in the peripheral portion, a sufficient effect of reducing doming cannot be obtained.

Under the recent circumstances of strict cost competition, it is difficult to adopt the means (A1) while considering the decrease in cost, and there is a limit to the suppression of color displacement merely with the means (A2) and (B 1). Thus, the effect of suppressing color displacement has not been obtained sufficiently with the conventional means.

### SUMMARY OF THE INVENTION

Therefore, with the foregoing in mind, it is an object of the present invention to provide a color cathode-ray tube wherein the color displacement caused by doming is reduced while a shadow mask is mounted, which is made of an inexpensive iron material and in which the increase in the difference in elevation between the center portion and the diagonal portion of the perforated region is suppressed.

A color cathode-ray tube of the present invention includes: a panel; a funnel connected to the panel; an electron gun provided in a neck of the funnel; and a substantially rectangular shadow mask provided so as to be opposed to an inner surface of the panel.

The shadow mask includes a perforated region in which a plurality of electron beam passage apertures are formed, a non-perforated region provided on a periphery of the perforated region, in which the electron beam passage apertures are not formed, and a skirt portion bent to the electron gun side with respect to the non-perforated region.

Then, assuming that a center of the perforated region is an origin, an axis that passes through the origin and is parallel to a long side of the shadow mask is an x-axis, an axis that passes through the origin and is parallel to a short side of the shadow mask is a y-axis, and a normal to the shadow mask at the origin is a z-axis, the following three conditions are satisfied.

First, curved surfaces on the x-axis and the y-axis in the perforated region are convex to the panel side.

Second, the perforated region has a curved surface that is convex to the panel side and a curved surface that is convex to the electron gun side on a periphery thereof.

Third, the perforated region has a curved surface that is convex to the panel side and a curved surface that is convex to the electron gun side in a region surrounded by the periphery, the x-axis, and the y-axis.

### BRIEF DESCRIPTION OF THE DRAWINGS

FIG. 1 is a perspective view of a shadow mask of a color cathode-ray tube according to Embodiment 1 of the present invention, seen from a panel side.

FIG. 2 is a perspective view of a shadow mask of a conventional color cathode-ray tube, seen from a panel side.

FIG. 3 is a perspective view of a shadow mask of a color cathode-ray tube according to Comparative Example 1, seen from a panel side.

FIG. 4 is a perspective view of a shadow mask of a color cathode-ray tube according to Comparative Example 2, seen from a panel side.

FIG. 5 is a perspective view of a shadow mask of a color cathode-ray tube according to Comparative Example 3, seen from a panel side.

FIGS. 6A to 6F are front views showing display patterns used for analyzing a landing movement amount.

FIG. 7 is a perspective view of a shadow mask of a color cathode-ray tube according to Embodiment 2 of the present invention, seen from a panel side.

FIG. 8 is an enlarged cross-sectional view of a vicinity of a non-perforated region along a plane that is parallel to a z-axis and is vertical to a plane of a skirt portion in the shadow mask of the color cathode-ray tube according to Embodiment 2 of the present invention.

FIG. 9 is an enlarged cross-sectional view of a vicinity of a non-perforated region along a plane that is parallel to a z-axis and is vertical to a plane of a skirt portion in another shadow mask of a color cathode-ray tube according to the present invention.

FIG. 10 is a perspective view of a shadow mask of another conventional color cathode-ray tube, seen from a panel side.

FIG. 11 is a perspective view of a shadow mask of a color cathode-ray tube according to Embodiment 3 of the present invention, seen from a panel side.

FIG. 12 is a cross-sectional view showing a schematic configuration of a general color cathode-ray tube.

FIG. 13 is a perspective view of a shadow mask structure of the general color cathode-ray tube.

### DETAILED DESCRIPTION OF THE INVENTION

According to the present invention, the perforated region of the shadow mask is provided with a special uneven curved surface. Consequently, in a region that is convex to a panel side, the curvature increases compared with the conventional example, so that the displacement amount in the z-axis direction during thermal expansion decreases, and the influence of doming on color displacement is reduced. In a region that is convex to an electron gun side, the deformation of the shadow mask caused by the thermal expansion is suppressed by the balance of stress. Thus, because of both effects, the color displacement caused by doming can be reduced at any place of the shadow mask.

In the present invention, the “curved surface that is convex to a panel side” refers to a dome-shaped curved surface swelling toward the panel side. More specifically, the curved surface that is convex to a panel side refers to a curved surface in which a curve formed by the surface of the perforated region in a cross-section including an axis parallel to the z-axis always protrudes toward the panel side irrespective of the direction of the cross-section.

On the other hand, the “curved surface that is convex to an electron gun side” refers to a curved surface in which, in at least one of a cross-section parallel to a plane including the x-axis and the z-axis and a cross-section parallel to a plane including the y-axis and the z-axis, a curve formed by the surface of the perforated region protrudes toward the electron gun side.

Under the above-mentioned first condition of the present invention, the curved surfaces on the x-axis and the y-axis in the perforated region are convex to the panel side. In other words, the first condition means that neither a curved surface which is convex to the electron gun side nor a flat surface are present on the x-axis and the y-axis in the perforated region. Herein, the “curved surface on the x-axis (or the y-axis) in the perforated region” refers to a curved surface of a region including a point on a curve obtained when the perforated region crosses a plane including the x-axis (or the y-axis) and the z-axis, and an area in the vicinity of the point.

Under the above-mentioned second condition of the present invention, the “curved surface on a periphery of the perforated region” refers to a curved surface of a region including a point on a periphery of the perforated region and an area in the vicinity of the point.

A direction directed from the shadow mask to the electron gun is set to be a positive direction of the z-axis. In the above-mentioned color cathode-ray tube of the present invention, assuming that z-coordinates of two points on a surface of the perforated region, which have the same y-coordinate and x-coordinates of x1 and x2, are z1 and z2, respectively, and x1<x2, it is preferable that a relationship z1<z2 is satisfied. Furthermore, assuming that z-coordinates of two points on the surface of the perforated region, which have the same x-coordinate and y-coordinates of y3 and y4, are z3 and z4, respectively, and y3<y4, it is preferable that a relationship z3<z4 is satisfied. According to this configuration, the perforated region has a curved surface whose z-axis coordinate increases monotonically with distance from the center (point which the z-axis passes). In general, the distance between the perforated region and the inner surface of the panel opposed to the perforated region is set to be substantially constant. Therefore, the inner surface of the panel also has a curved surface whose z-axis coordinate increases monotonically with distance from a center. Consequently, the inner surface of the panel can be coated with phosphors substantially uniformly.

Furthermore, it is preferable that a z-coordinate of a point on a surface of the perforated region is, with an x-coordinate of the point being a variable x, represented by an m-order function of the variable x on the x-axis, represented by a cosine function of the variable x on a long side of the perforated region, and represented by a function including at least the m-order function of the variable x and the cosine function of the variable x in a region between the x-axis and the long side.

Alternatively, it is preferable that a z-coordinate of a point on a surface of the perforated region is, with a y-coordinate of the point being a variable y, represented by an n-order function of the variable y on the y-axis, represented by a cosine function of the variable y on a short side of the perforated region, and represented by a function including at least the n-order function of the variable y and the cosine function of the variable y in a region between the y-axis and the short side.

Furthermore, it is more preferable that the above-mentioned preferable two embodiments are provided simultaneously. That is, it is preferable that a z-coordinate of a point on a surface of the perforated region is, with an x-coordinate and a y-coordinate of the point being a variable x and a variable y, represented by an m-order function of the variable x on the x-axis, represented by an n-order function of the variable y on the y-axis, represented by a cosine function of the variable x on a long side of the perforated region, a cosine function of the variable y on a short side of the perforated region, and represented by a function including at least the m-order function of the variable x, the n-order function of the variable y, the cosine function of the variable x, and the cosine function of the variable y in a region surrounded by the x-axis, the y-axis, the long side, and the short side.

It is preferable that assuming that an x-coordinate of a point where a pair of short sides of the perforated region and the x-axis cross each other is ±X_{P}, a z-coordinate thereof is Z_{XP}, a y-coordinate of a point where a pair of long sides of the perforated region and the y-axis cross each other is ±Y_{P}, a z-coordinate thereof is Z_{YP}, and a z-coordinate of a point where a periphery of the perforated region and a diagonal axis of the perforated region cross each other is Z_{DP} (X_{P}, Y_{P}, Z_{XP}, Z_{YP}, Z_{DP}≠0), a z-coordinate of an arbitrary point on the surface of the perforated region is approximated by the following Expression 1 with an x-coordinate and a y-coordinate of the arbitrary point being variables x and y

$$z ( x , y ) = γ [ α {z}_{x 1} ( x ) + \{ 1 - α \} {z}_{x 2} ( x ) ] + {z}_{y 1} ( y ) , \\ α = \frac{1}{2} \{ 1 + cos ( \frac{π}{{Y}_{P}} y ) \} , γ = 1 + \frac{{z}_{yS} ( y ) - {z}_{y 1} ( y )}{{Z}_{XP}} , \\ {z}_{x 1} ( x ) = {ax}^{m} , a = \frac{{Z}_{XP}}{{X}_{p}^{m}} , m \geq 0 , \\ {z}_{x 2} ( x ) = b \{ 1 - cos ( \frac{π}{{X}_{P}} x ) \} , b = \frac{1}{2} {Z}_{XP} , \\ {z}_{y 1} ( y ) = {cy}^{n} , c = \frac{{Z}_{YP}}{{Y}_{P}^{n}} , n \geq 0 , \\ {z}_{yS} ( y ) = d \{ 1 - cos ( \frac{π}{{Y}_{P}} y ) \} , d = \frac{1}{2} ( {Z}_{DP} - {Z}_{XP} ) . \qquad Expression 1 \text{:}$$

It is preferable that, in the Expression 1, Zₓ₂(x) is represented by

$${z}_{x 2} ( x ) = b [ 1 - {\sum }_{λ = 1}^{h} \{ R {1}_{λ} cos ( λ \frac{π}{{X}_{P}} x ) \} + C 1 ]$$

$$( R {1}_{μ} \text{:} Constant with respect to each λ , C 1 \text{:} Constant )$$

where a term of a cosine function is replaced with a cosine series. According to this configuration, the overall doming amount can be balanced by minutely adjusting the curved surface shape locally.

It is preferable that, in the Expression 1, α is represented by

$$α = \frac{1}{2} [ 1 + {\sum }_{μ = 1}^{i} \{ R {2}_{μ} cos ( μ \frac{π}{{Y}_{P}} y ) \} + C 2 ]$$

$$( R {2}_{μ} \text{:} Constant with respect to each μ , C 2 \text{:} Constant )$$

where a term of a cosine function is replaced with a cosine series. According to this configuration, the curved surface shape can be adjusted more finely.

It is preferable that, in the Expression 1, Z_{yS}(y) is represented by

$${z}_{yS} ( y ) = d [ 1 - {\sum }_{ν = 1}^{j} \{ R {3}_{ν} cos ( ν \frac{π}{{Y}_{P}} y ) \} + C 3 ]$$

$$( R {3}_{v} \text{:} Constant with respect to each ν , C 3 \text{:} Constant )$$

where a term of a cosine function is replaced with a cosine series. According to this configuration, the curved surface shape in the vicinity of short sides can be adjusted finely.

It is preferable that the non-perforated region connects the perforated region to the skirt portion with a smooth curve in a cross-section that is parallel to the z-axis and vertical to a plane of the skirt portion. Furthermore, it is preferable that a radius of curvature of the non-perforated region is maximum in a diagonal direction passing through a diagonal axis end of the shadow mask. Herein, the “radius of curvature of a non-perforated region” refers to a radius of curvature in a portion having a smallest radius of curvature in the curve formed by the outer surface of the non-perforated region in a cross-section that is parallel to the z-axis and is vertical to a plane of the skirt portion. More specifically, it is preferable that the radius of curvature of the non-perforated region gradually increases with distance from the x-axis and the y-axis, and becomes maximum on the diagonal axis. Because of this, the doming swelling to the electron gun side in the vicinity of the diagonal axis end of the perforated region when the entire perforated region is irradiated with the electron beams can be reduced.

Alternatively, the non-perforated region may have a linear portion in a cross-section that is parallel to the z-axis and is vertical to a plane of the skirt portion.

It is preferable that the shadow mask is made of a material containing Fe as a main component. This can decrease material cost. Herein, “containing Fe as a main component” refers to containing at least 50% Fe.

It is preferable that the shadow mask has an electron reflective coating film on a surface thereof opposed to the electron gun. This increases the electron reflective amount of the shadow mask, so that the increase in temperature of the shadow mask is suppressed, and the doming amount can be reduced. Herein, although there is no particular limit to the electron reflective coating film, in general, a film containing an oxide of a substance having a large atomic weight is preferable in terms of the electron reflection. A specific example of the electron reflective coating film includes a film obtained by mixing oxide particles of zinc, bismuth, or the like with a binder such as liquid glass, followed by coating.

It is preferable that the perforated region has a plurality of tie-bands with a longitudinal direction thereof being the y-axis direction, and unevenness is formed by half-etching on surfaces of the plurality of tie-bands. When unevenness is formed in the perforated region, separately from the electron beam passage apertures, the surface area thereof increases, so that the thermal radiation amount increases. Consequently, the increase in temperature of the shadow mask is suppressed to reduce the doming amount.

Hereinafter, the present invention will be described in more detail by way of embodiments with reference to the drawings.

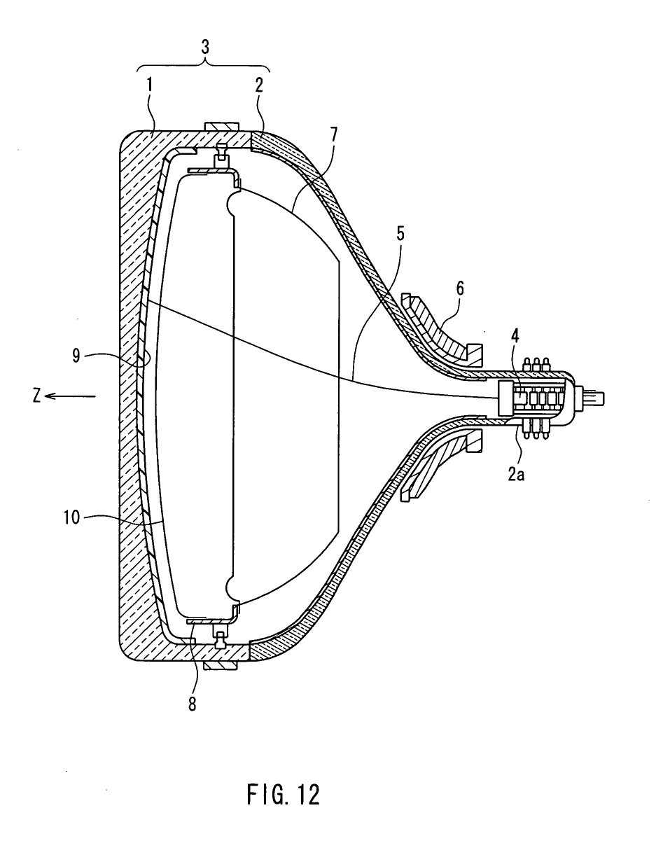

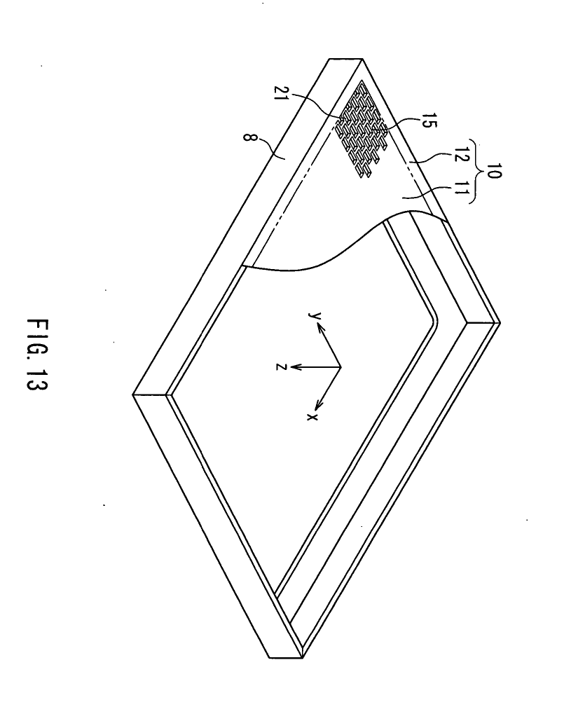

The basic configuration of the color cathode-ray tube of the present invention is not particularly limited except for a shadow mask, and may be similar to a conventional general configuration shown in FIG. 12. Thus, the description of the entire configuration of the color cathode-ray tube will be omitted so as to avoid the redundancy.

Embodiment 1

FIG. 1 is a perspective view showing the state of a shadow mask 10 as a single element before being welded to a frame 8 of a color cathode-ray tube according to Embodiment 1 of the present invention, seen from a panel 1 side. The shadow mask 10 in a substantially rectangular shape is made of a metallic thin plate, and includes a substantially rectangular perforated region 11 in which a number of slot-shaped or dot-shaped electron beam passage apertures are provided, a non-perforated region 12 placed on the periphery of the perforated region 11, and a skirt portion 13 bent to an electron gun side at a substantially right angle with respect to the non-perforated region 12. In the same way as in the conventional shadow mask shown in FIG. 13, the shadow mask 10 has a plurality of tie-bands with a longitudinal direction thereof being a y-axis direction and a plurality of bridges connecting the tie-bands adjacent to each other in an x-axis direction in the perforated region 11, and a plurality of electron beam passage apertures are formed between the tie-bands adjacent to each other in the x-axis direction. In FIG. 1, the detailed configurations of the tie-bands, the bridges, and the electron beam passage apertures are omitted, and a lattice pattern is drawn instead in the perforated region 11, whereby the curved surface shape thereof is expressed.

Assuming that the center of the perforated region 11 is an origin, an axis that passes through the origin and is parallel to a long side of the shadow mask 10 is an x-axis, an axis that passes through the origin and is parallel to a short side of the shadow mask 10 is a y-axis, and a normal to the shadow mask 10 at the origin is a z-axis, a z-coordinate of a point on a plane of the perforated region 11 of the shadow mask 10 is represented by an m-order function of a variable x on the x-axis, represented by an n-order function of a variable y on the y-axis, represented by a cosine function of the variable x on a long side of the perforated region 11, represented by a cosine function of the variable y on a short-side of the perforated region 11, and represented by a function including four functions: the m-order function of the variable x, the n-order function of the variable y, the cosine function of the variable x, and the cosine function of the variable y in a region surrounded by the x-axis, the y-axis, the long-side, and the short-side. Consequently, the curved surfaces on the x-axis and the y-axis of the perforated region 11 are convex to the panel 1 side, the perforated region 11 includes a curved surface that is convex to the panel 1 side and a curved surface that is convex to the electron gun 4 side on the periphery (boundary with respect to the perforated region 12), and the perforated region 11 has a curved surface that is convex to the panel 1 side and a curved surface that is convex to the electron gun 4 side in a region surrounded by the periphery, the x-axis, and the y-axis. The shadow mask 10 having such a curved surface shape can be formed by press forming using a die.

An example will be shown, in which the present invention is applied to a color cathode-ray tube for a TV with a diagonal size of 68 cm and an aspect ratio of 4:3.

The shadow mask 10 is made of a metallic plate material (thickness T =0.25 mm) containing Fe as a main component. Assuming that an x-coordinate of a point (x-axis end) where a pair of short sides of the perforated region 11 and the x-axis cross each other is ±X_{P}, a z-coordinate thereof is Z_{XP}, a y-coordinate of a point (y-axis end) where a pair of long sides of the perforated region 11 and the y-axis cross each other is ±Y_{P}, a z-coordinate thereof is Z_{YP}, and a z-coordinate of a point (diagonal axis end) where the periphery of the perforated region 11 and the diagonal axis of the perforated region 11 cross each other is Z_{DP}, X_{P}=253 mm, Z_{XP}=23.7 mm, Y_{P}=190 mm, Z_{YP}=10.3 mm, and Z_{DP}=23.7 mm. The z-coordinate of an arbitrary point on the surface of the perforated region 11 of the shadow mask 10 is represented by the following Expression 2 with the x-coordinate and the y-coordinate of the arbitrary point being variables x and y.

$$z ( x , y ) = γ [ α {z}_{x 1} ( x ) + \{ 1 - α \} {z}_{x 2} ( x ) ] + {z}_{y 1} ( y ) , \\ α = \frac{1}{2} \{ 1 + cos ( \frac{π}{{Y}_{P}} y ) \} , γ = 1 + \frac{{z}_{y 1} ( y )}{{Z}_{XP}} , \\ {z}_{x 1} ( x ) = {ax}^{4} , a = \frac{{Z}_{XP}}{{X}_{P}^{4}} , \\ {z}_{x 2} ( x ) = b [ \begin{matrix}1 - \{ cos ( \frac{π}{{X}_{P}} x ) - \\ 0.2 cos ( 2 \frac{π}{{X}_{P}} x ) \} - 0.2\end{matrix} ] , \\ b = \frac{1}{2} {Z}_{XP} , \\ {z}_{y 1} ( y ) = {cy}^{3} , c = \frac{{Z}_{YP}}{{Y}_{P}^{3}} \qquad Expression 2 \text{:}$$

Expression 2 is obtained by setting Z_{DP}=Z_{XP} and replacing the term of a cosine function of Zₓ₂(x) with the first and second terms of a cosine series in Expression 1.

The non-perforated region 12 of the shadow mask 10 has a smooth curved surface connecting the perforated region 11 to the skirt portion 13, and has a curved surface obtained by extending the curved surface of the perforated region 11 in the vicinity of the perforated region 11.

A calculation model of the shadow mask 10 for a color cathode-ray tube apparatus for a TV with a diagonal size of 68 cm based on Expression 2 was produced on a computer. This calculation model is assumed to be “Example 1”.

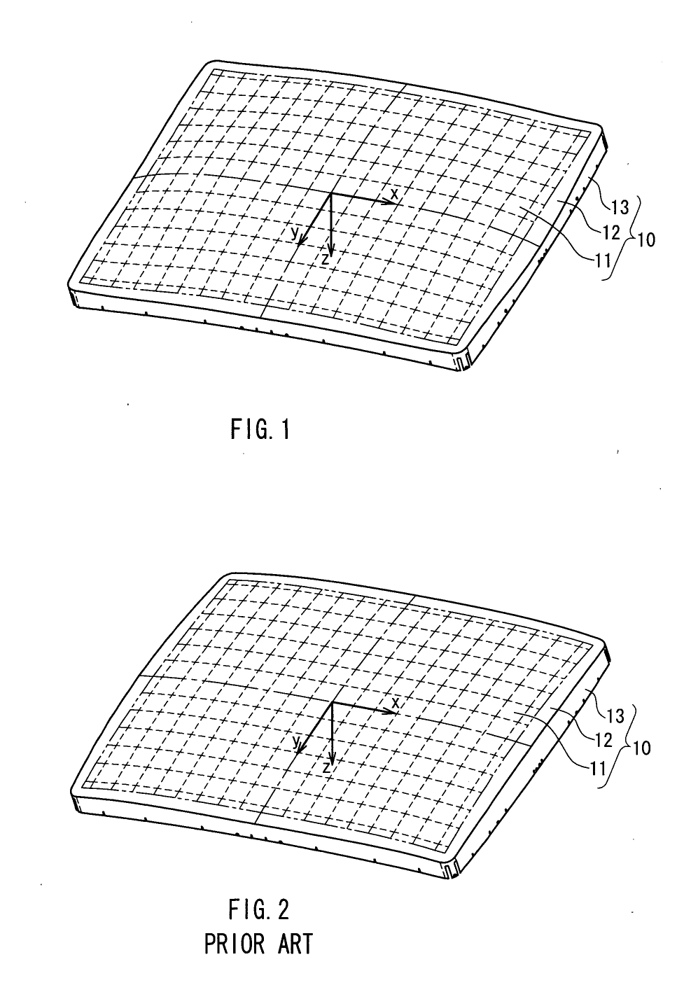

FIG. 2 is a perspective view of an exemplary conventional shadow mask in which a function (hereinafter, referred to as a “curved surface function”) representing the curved surface shape of the perforated region 11 does not include a cosine function. The perforated region 11 of the shadow mask 10 has a curved surface shape that is convex to the panel 1 side over the entire region thereof, and the z-coordinate of a diagonal axis end is Z_{DP}=23.7 mm, which is the same as that of Example 1. In this case, the curved surface shape of the perforated region 11 was optimized so that the landing movement amount described later became minimum. At this time, Z_{XP}=11.6 mm, and Z_{YP}=10.3 mm. The z-coordinate of an arbitrary point on the surface of the perforated region 11 is represented by the following Expression 3 that is a polynomial of variables x, y with the x-coordinate and the y-coordinate of the arbitrary point being the variables x and y.
z(x, y)=u₁x²+u₂x⁴+u₃x⁶+u₄y²+u₅x²y²+u₆y⁴+u₇y⁶, Expression 3
u₁=1.17×10⁻⁵, u₂=3.43×10⁻⁹, u₃=−1.22×10⁻¹⁴, u₄=3.10×10⁻⁴, u₅=7.79×10⁻¹⁰, u₆=−1.48×10⁻⁹, u₇=2.25×10⁻¹⁴

A calculation model of the shadow mask 10 for a color cathode-ray tube apparatus for a TV with a diagonal size of 68 cm based on Expression 3 was produced on a computer. This calculation model is assumed to be “Conventional Example 1”.

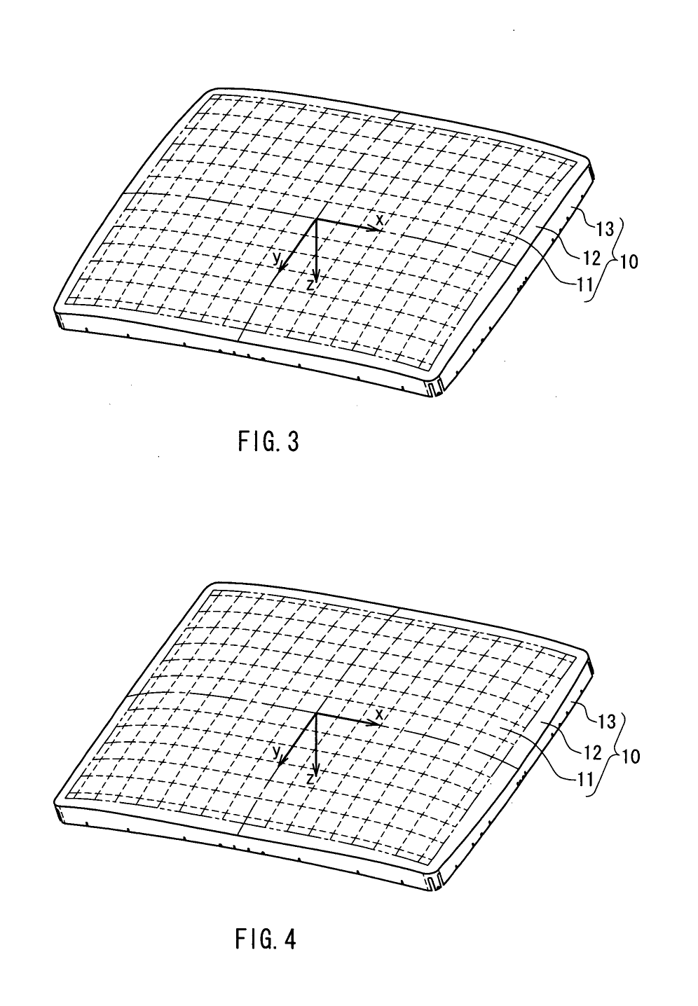

FIG. 3 is a perspective view of a shadow mask in which the curved surface shape of the perforated region 11 is represented by a function obtained by removing a cosine function from the curved surface function of the perforated region 11 in Example 1. The perforated region 11 of the shadow mask 10 basically has a shape similar to that of Conventional Example 1. Specifically, the perforated region 11 has a curved surface shape that is convex to the panel 1 side represented by a quartic function of the variable x in the x-axis direction, and has a curved surface shape that is convex to the panel 1 side represented by a cubic function of the variable y in the y-axis direction. Z_{XP}=13.4 mm, Z_{YP}=10.3 mm, and Z_{DP}=23.7 mm. The z-coordinate of an arbitrary point on the surface of the perforated region 11 is represented by the following Expression 4 with the x-coordinate and y-coordinate of the arbitrary point being variables x and y.

$$z ( x , y ) = {ax}^{4} + {cy}^{3} , \\ a = \frac{{Z}_{XP}}{{X}_{P}^{4}} , c = \frac{{Z}_{YP}}{{Y}_{P}^{3}} \qquad Expression 4 \text{:}$$

A calculation model of the shadow mask 10 for a color cathode-ray tube apparatus for a TV with a diagonal size of 68 cm based on Expression 4 was produced on a computer. This calculation model is assumed to be “Comparative Example 1”.

FIG. 4 is a perspective view of a shadow mask in which Z_{XP} is changed to 23.7 mm in Comparative Example 1. The z-coordinate of an arbitrary point on the surface of the perforated region 11 of the shadow mask 10 is represented by the following Expression 5 with the x-coordinate and y-coordinate of the arbitrary point being variables x and y.

$$z ( x , y ) = γ {ax}^{4} + {cy}^{3} , \\ γ = 1 - \frac{{cy}^{3}}{{Z}_{XP}} , a = \frac{{Z}_{XP}}{{X}_{P}^{4}} , c = \frac{{Z}_{YP}}{{Y}_{P}^{3}} \qquad Expression 5 \text{:}$$

A calculation model of the shadow mask 10 for a color cathode-ray tube apparatus for a TV with a diagonal size of 68 cm based on Expression 5 was produced on a computer. This calculation model is assumed to be “Comparative Example 2”.

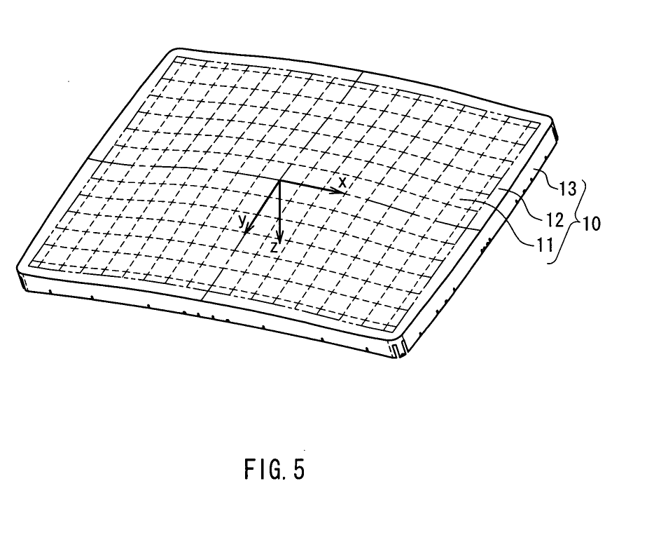

FIG. 5 is a perspective view of a shadow mask in which the curved surface shape of the perforated region 11 is represented by a function obtained by removing a portion other than a cosine function from a curved surface function of the perforated region 11 of Example 1. Z_{XP}=23.7 mm, Z_{YP}=10.3 mm, and Z_{DP}=23.7 mm. The z-coordinate of an arbitrary point on the surface of the perforated region 11 is represented by the following Expression 6 with the x-coordinate and the y-coordinate of the arbitrary point being variables x and y.

$$z ( x , y ) = γ {z}_{x 2} ( x ) + {z}_{y 2} ( y ) , \\ γ = 1 - \frac{{z}_{y 2} ( y )}{{Z}_{XP}} , \\ {z}_{x 2} ( x ) = b [ \begin{matrix}1 - \{ cos ( \frac{π}{{X}_{P}} x ) - \\ 0.2 cos ( 2 \frac{π}{{X}_{P}} x ) \} - 0.2\end{matrix} ] , \\ b = \frac{1}{2} {Z}_{XP} , \\ {z}_{y 2} ( y ) = p \{ 1 - cos ( \frac{π}{{Y}_{P}} y ) \} , p = \frac{1}{2} {Z}_{YP} \qquad Expression 6 \text{:}$$

A calculation model of the shadow mask 10 for a color cathode-ray tube apparatus for a TV with a diagonal size of 68 cm based on Expression 6 was produced on a computer. This calculation model is assumed to be “Comparative Example 3”.

Regarding the color cathode-ray tube apparatuses of Example 1, Conventional Example 1, and Comparative Examples 1, 2, and 3, the amount (hereinafter, referred to as a “landing movement amount”) by which the position where an electron beam strikes a phosphor screen is shifted in the x-axis direction due to doming caused by various kinds of heating patterns described later was calculated. This calculation generally can be analyzed using analyzing software (e.g., “ANSYS” produced by ANSYS Inc.) based on a commercially available finite element method. The calculation conditions are as follows.

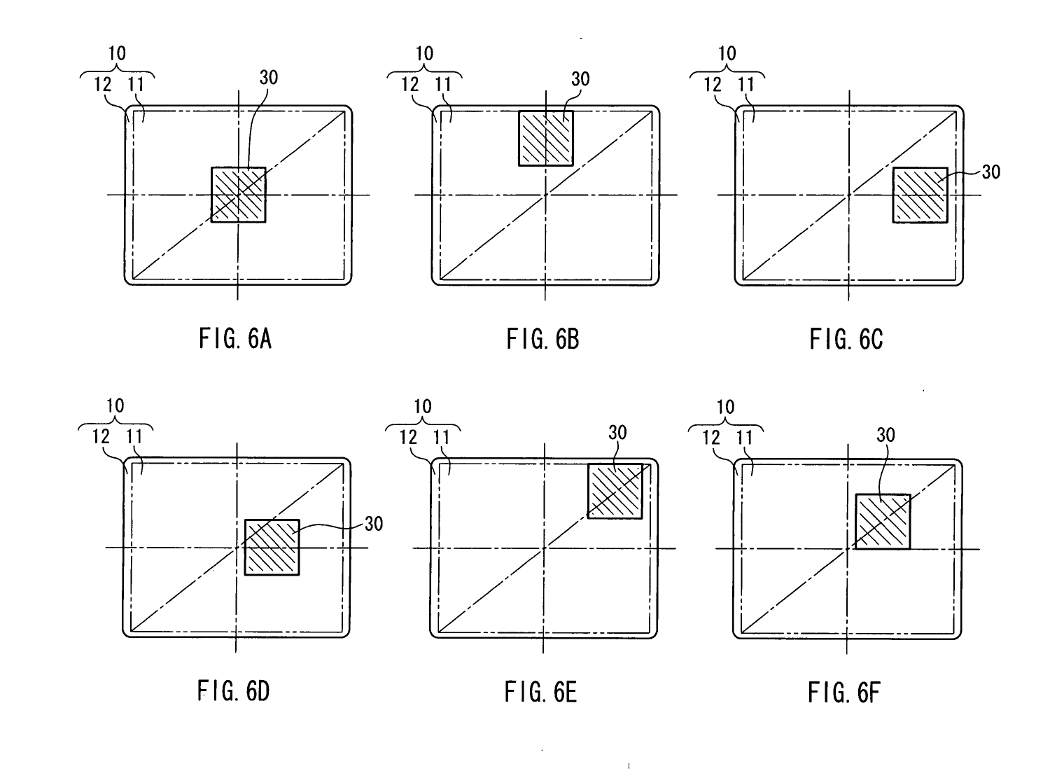

FIGS. 6A to 6F are front views of the shadow mask 10 seen from a side of a plane opposed to the panel 1. A shaded region 30 shows a square electron beam irradiated region with a side of 126 mm. Assuming the case where the shadow mask 10 is set in an atmosphere at room temperature of 25° C., and only the region 30 is irradiated with electron beams to raise the temperature of the region 30 to 60° C., whereby local doming occurs, the landing movement amount of the electron beams 5 in this case was calculated by varying the position of the region 30, respectively. Regarding the (x, y) coordinate in the perforated region 11, a center (i.e., the origin) is (0, 0), an x-axis end is (±X_{P}, 0), and a y-axis end is (0, ±Y_{P}). FIG. 6A is a view showing the case where the center of the region 30 is positioned at the origin (0, 0). FIG. 6B is a view showing one of two cases where the center of the region 30 is positioned at a coordinate (0, ±2Y_{P}/3). FIG. 6C is a view showing one of two cases where the center of the region 30 is positioned at a coordinate (±2X_{P}/3, 0). FIG. 6D is a view showing one of two cases where the center of the region 30 is positioned at a coordinate (±X_{P}/3, 0). FIG. 6E is a view showing one of four cases where the center of the region 30 is positioned at a coordinate (±2X_{P}/3, ±2Y_{P}/3). FIG. 6F is a view showing one of four cases where the center of the region 30 is positioned at a coordinate (±X_{P}/3, ±Y_{P}/3).

Table 1 shows the maximum values of the calculation results of the landing movement amounts at the respective electron beam irradiated positions. (A) to (F) in Table 1 correspond to FIGS. 6A to 6F in this order. The landing movement amount shown in Table 1 is a relative value assuming that the maximum value of the landing movement amount (the landing movement amount when the electron beam irradiated region 30 is placed at a position shown in FIG. 6F) in Conventional Example 1 is 100%. Furthermore, the landing movement amount is displayed as an absolute value without considering the movement direction along the x-axis. Thus, it is preferable that the numerical value of the landing movement amount shown in Table 1 is as small as possible. Furthermore, it is preferable that the variation in the value of the landing movement amount among (A) to (F) in Table 1 is smaller.

TABLE 1

| | Conventional | | Comparative | Comparative | Comparative |
|---|---|---|---|---|---|
| Irradiated position | Example 1 | Example 1 | Example 1 | Example 2 | Example 3 |
| (A) Center | 56% | 61% | 92% | 79% | 17% |
| (B) Upper or lower ⅔ | 50% | 20% | 37% | 33% | 89% |
| (C) Right or left ⅔ | 99% | 54% | 116% | 92% | 233% |
| (D) Right or left ⅓ | 99% | 63% | 142% | 104% | 83% |
| (E) Diagonal ⅔ | 78% | 64% | 53% | 55% | 134% |
| (F) Diagonal ⅓ | 100% | 60% | 105% | 82% | 98% |

It is understood from Table 1 that, in any of the cases (A) to (F), the landing movement amount in Example 1 is smaller than that of Conventional Example 1, and is suppressed to 64% or less of the maximum value of Conventional Example 1. The reason for this is considered to be as follows. In Example 1, by setting the perforated region 11 to be a curved surface shape represented by Expression 2, the curvature in the y-axis direction on the x-axis was able to be increased while the difference in elevation Z_{DP} in the z-axis direction between the center and the diagonal axis end of the perforated region 11 was kept to be the same as that of Conventional Example 1. Therefore, the landing movement amounts in (C) and (D)) became small. Furthermore, since the perforated region 11 had a curved surface that was convex to the electron gun 4 side in the vicinity of the diagonal axis end, the landing movement amounts in (E) and (F) became small.

It is preferable that the z-coordinate of a point on the surface of the perforated region 11 is represented by the m-order function of the variable x on the x-axis, the n-order function of the variable y on the y-axis, and the function including a cosine function so as to obtain a curved surface that is convex to the electron gun 4 side in a region away from the x-axis and the y-axis. This will be described below.

First, the perforated region 11 of Comparative Example 1 has the simplest shape represented by a curved surface function obtained by removing a cosine function from the curved surface function in Example 1. In this case, as is understood from Table 1, the landing movement amounts in (A), (C), (D), and (F) are degraded compared with that of Conventional Example 1. It is understood that when a cosine function is removed from a curved surface function, the influence of doming on the landing movement amount changes greatly. In other words, it can be said that the curved surface function in Conventional Example 1 was optimized relatively satisfactorily with respect to the landing movement amount.

Next, the curved surface shape of the perforated region 11 of Comparative Example 2 is represented by a curved surface function in the case where the values of the z-coordinates Z_{XP}, Z_{YP} at the x-axis end and the y-axis end are set to be the same as those in Example 1 in the curved surface function of Comparative Example 1. In this case, although the landing movement amount is reduced compared with that of Comparative Example, it is degraded compared with that of Conventional Example 1 in (D). It is understood from these facts that preferable results cannot be obtained even when the values of the z-coordinates Z_{XP}, Z_{YP} at the x-axis end and the y-axis end are matched with those of Example 1.

Next, the curved surface shape of the perforated region 11 of Comparative Example 3 is represented by only a cosine function, without using the m-order function of the variable x on the x-axis and the n-order function of the variable y on the y-axis as in the curved surface function in Example 1. In this case, although only the landing movement amount in (A) is reduced greatly, the landing movement amounts in (C) and (E) are degraded greatly. The reason for this is considered as follows: the curvatures in the x-axis direction and the y-axis direction at the x-axis end become small.

Thus, according to Embodiment 1, a color cathode-ray tube can be provided in which the color displacement caused by the doming of the shadow mask 10 is reduced.

The curved surface similar to that of Example 1 can be expressed even using Expression 7 in place of Expression 1.

$$z ( x , y ) = δ ⌊ β {z}_{y 1} ( y ) + \{ 1 - β \} {z}_{y 2} ( y ) ⌋ + {z}_{x 1} ( x ) , \\ β = \frac{1}{2} \{ 1 + cos ( \frac{π}{{X}_{P}} x ) \} , δ = 1 + \frac{{z}_{xS} ( x ) - {z}_{x 1} ( x )}{{Z}_{YP}} , \\ {z}_{y 1} ( y ) = {cy}^{n} , c = \frac{{Z}_{YP}}{{Y}_{P}^{n}} , n \geq 0 , \\ {z}_{y 2} ( x ) = p [ 1 - {\sum }_{η = 1}^{k} \{ R {4}_{η} cos ( η \frac{π}{{Y}_{P}} y ) \} + C 4 ] , \\ ( \begin{matrix}R {4}_{η} \text{:} Constant with respect to \\ each η , C 4 \text{:} Constant\end{matrix} ) \\ p = \frac{1}{2} {Z}_{YP} , \\ {z}_{x 1} ( x ) = {ax}^{m} , a = \frac{{Z}_{XP}}{{X}_{P}^{m}} , m \geq 0 , \\ {z}_{xS} ( x ) = q \{ 1 - cos ( \frac{π}{{X}_{P}} x ) \} , q = \frac{1}{2} ( {Z}_{DP} - {Z}_{YP} ) \qquad Expression 7 \text{:}$$

In Expression 7, the term of the cosine function of β and the term of the cosine function of Z_{xS} may be replaced by a cosine series in the same way as in Expression 1.

In Expression 2 that is the curved surface function in Example 1, the curved surface on the x-axis is expressed using z=ax⁴ and the curved surface on the y-axis is expressed using z=cy³. However, the present invention is not limited thereto, and a polynomial of an arbitrary order may be used. Alternatively, other functions may be used as long as a curved surface that is convex to the panel 1 side is obtained on the x-axis and the y-axis.

Furthermore, in Expression 2 that is a curved surface function of Example 1, the curved surface shape of the region away from the x-axis and the y-axis is expressed by the function including a cosine function. However, other functions may be used as long as a curved surface that is convex to the electron gun side may be obtained in a region (i.e., a region including a diagonal axis end and the vicinity thereof) away from the x-axis and the y-axis.

Embodiment 2

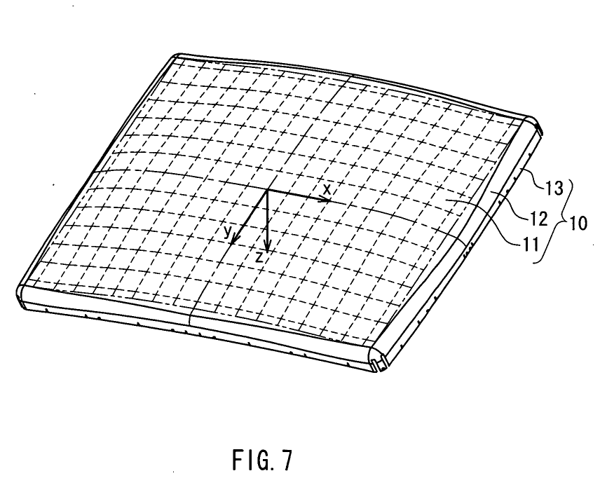

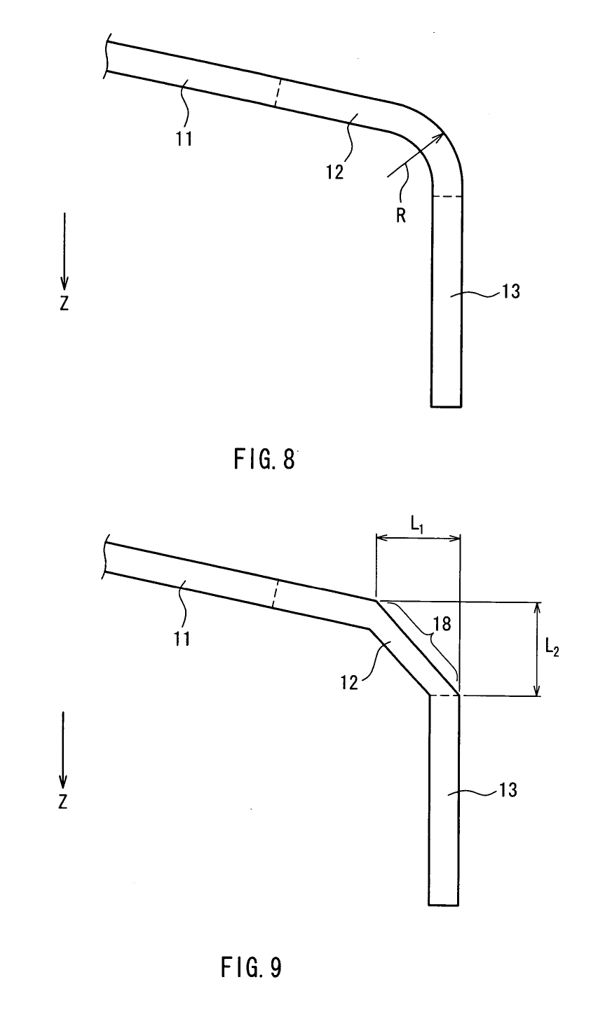

FIG. 7 is a perspective view of a shadow mask 10 of a color cathode-ray tube according to Embodiment 2 of the present invention, seen from a side opposed to a panel 1. FIG. 8 is an enlarged cross-sectional view of the vicinity of a non-perforated region 12 along a plane that is parallel to a z-axis and vertical to the plane of a skirt portion 13. In the same way as in Embodiment 1, in the shadow mask 10 of Embodiment 2, the non-perforated region 12 has a curved surface connecting a perforated region 11 to the skirt portion 13 smoothly, and has a curved surface obtained by extending the curved surface of the perforated region 11 in a region in the vicinity of the perforated region 11, whereby the non-perforated region 12 has a curved surface independent from the perforated region 11 in an area on the skirt portion 13 side. Herein, the term “independent” refers to the function representing a curved surface shape of a certain region being different from the function representing a curved surface shape of a region adjacent to the certain region.

An example corresponding to Embodiment 2 will be shown. In the shadow mask 10, the shape of the non-perforated region 12 does not directly influence the landing movement amount. In Example 1, the surface shape of the non-perforated region 12 was set to be a curved surface obtained by connecting regions among the x-axis end, the y-axis end, and the diagonal axis end with a smooth curved surface so that the radius of curvature in the x-axis direction passing through the x-axis end was 14 mm, the radius of curvature in the y-axis direction passing through the y-axis end was 10 mm, and the radius of curvature in the diagonal direction passing through the diagonal axis end was 15 mm, and the radius of curvature changed gradually in these regions. Herein, the “radius of curvature” refers to a radius of curvature R of a portion having the smallest radius of curvature in the curved surface formed by the outer surface of the non-perforated region 12 in FIG. 8. A calculation model of the shadow mask 10 for a color cathode-ray tube apparatus for a TV with a diagonal size of 68 cm having the above shape was produced on a computer. This calculation model is assumed to be “Example 2”. In the above-mentioned Example 1, the surface shape of the non-perforated region 12 was set to be a curved surface in which the radius of curvature in the x-axis direction passing through the x-axis end, the radius of curvature in the y-axis direction passing through the y-axis end, the radius of curvature in the diagonal direction passing through the diagonal axis end, and the radius of curvature in a region between them were set to be 0.25 mm.

Table 2 shows maximum values of the calculation results of the landing movement amounts in Conventional Example 1, Example 1, and Example 2 in the same way as in Table 1.

TABLE 2

| | Conventional | | |
|---|---|---|---|
| Irradiated position | Example 1 | Example 1 | Example 2 |
| (A) Center | 56% | 61% | 61% |
| (B) Upper or lower ⅔ | 50% | 20% | 19% |
| (C) Right or left ⅔ | 99% | 54% | 58% |
| (D) Right or left ⅓ | 99% | 63% | 63% |
| (E) Diagonal ⅔ | 78% | 64% | 67% |
| (F) Diagonal ⅓ | 100% | 60% | 59% |
| (G) Entire region | 79% | 87% | 69% |

In Table 2, in addition to the calculation results of the respective. landing movement amounts in the electron beam irradiated regions 30 in FIGS. 6A to 6F, the calculation results of the landing movement amounts during overall doming occurring due to the increase in temperature to 60° C. of the entire perforated region 11 are shown in row (G). The values in (G) were obtained as follows. The shift amount of a striking position of an electron beam with respect to the phosphor screen in the x-axis direction caused by the doming was calculated over the entire region of the phosphor screen with the case approaching the center (origin) of the perforated region 11 being negative (−), and the case leaving the center (origin) of the perforated region 11 being positive (+). Then, the sum of the positive maximum value and the absolute value of the negative maximum value was shown as a relative value with the landing movement amount in (F) of Conventional Example 1 being 100%.

The landing movement amount in (G) of Table 2 is 87% in Example 1, which shows an increase compared with 79% in Conventional Example 1. The landing movement amount in (G) is caused by the overall doming, and basically can be corrected to some degree with a spring (not shown) fixed to the frame 8, for mounting the frame 8 to the panel 1. Therefore, this does not cause a serious problem under the present circumstances. However, the increase in the correction amount is not preferable in terms of the mechanism. In contrast, in Example 2, the landing movement amount in (G) is 69%, which shows the reduction compared with Conventional Example 1. Furthermore, in Example 2, the landing movement amounts in (A) to (F) are substantially the same as those of Example 1. Accordingly, considering also the color displacement caused by the overall doming, it is understood that Example 2 has more satisfactory characteristics with good balance with respect to the color displacement caused by doming.

The above-mentioned Embodiments 1 and 2 show the case where the non-perforated region 12 has a curved surface connecting the perforated region 11 to the skirt portion 13 smoothly. However, the present invention is not limited thereto. For example, as shown in FIG. 9, in a cross-section that is parallel to the z-axis and vertical to the plane of the skirt portion 13, the non-perforated region 12 may have a linear portion 18. A calculation model of the shadow mask 10 for a color cathode-ray tube apparatus for a TV with a diagonal size of 68 cm was produced on a computer, in which the curved surface shape of the non-perforated region 12 was changed to a shape having, over the entire periphery, the linear portion 18 with a size L₁ in a direction along an XY-plane (plane orthogonal to the z-axis) shown in FIG. 9 being 7 mm, and a size L₂ in the z-axis direction shown in FIG. 9 being 7 mm in the above-mentioned Example 1. The calculation result of the landing movement amount (value corresponding to (G) in Table 2) during the overall doming occurring due to the increase in temperature to 60° C. of the entire perforated region 11 regarding the shadow mask 10 was 70%, which was substantially equal to that of Example 2.

Embodiment 3

In Embodiments 1 and 2, the effect of the present invention has been described using the examples, the conventional example, and the comparative examples in which the z-coordinate Z_{DP} of the diagonal axis end of the perforated region 11 of the shadow mask 10 is unified to be 23.7 mm. In Embodiment 3, the effect of the present invention in the case where the z-coordinate Z_{DP} of the diagonal axis end is changed will be described.

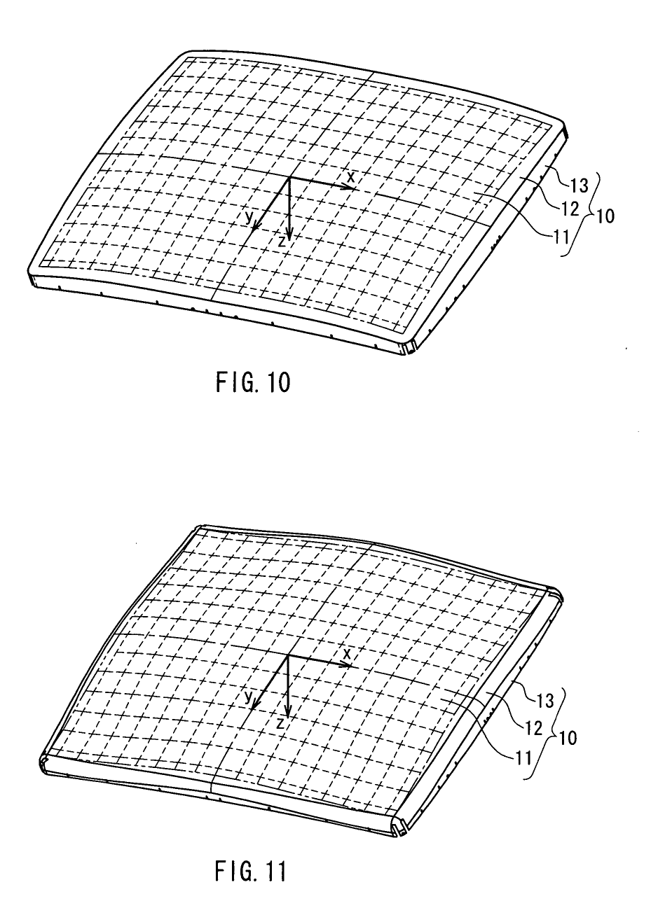

FIG. 10 is a perspective view of another conventional exemplary shadow mask in which the curved surface function of the perforated region 11 does not include a cosine function. The shadow mask is an example in which the z-coordinate Z_{DP} of the diagonal axis end of the perforated region 11 is set to be larger than that of Conventional Example 1. When the z-coordinate Z_{DP} of the diagonal axis end is increased, although the effect of reducing doming increases as described in the background art, an image becomes dark in a peripheral portion of the screen. In the case where it is desired to reduce doming even by compromising the uniformity of lightness to some decree, such a design is adopted. Specifically, Z_{XP}=17.4 mm, Z_{YP}=13.0 mm, and Z_{DP}=31.2 mm, and the z-coordinate of an arbitrary point on the surface of the perforated region 11 is represented by the following Expression 8 with the x-coordinate and the y-coordinate of the arbitrary point being variables x and y.
z(x, y)=u₁x²+u₂x⁴+u₃x⁶+u₄y²+u₅x²y²+u₆y⁴+u₇y⁶, Expression 8
u₁=9.60×10⁻⁶, u₂=6.31×10⁻⁹, u₃=−3.46×10⁻¹⁴, u₄=3.95×10⁻⁴, u₅=3.67×10⁻¹⁰, u₆=−01.44×10⁻⁹, u₇=1.23×10⁻¹⁴

A calculation model of the shadow mask 10 for a color cathode-ray tube apparatus for a TV with a diagonal size of 68 cm based on Expression 8 was produced on a computer. This calculation model is assumed to be “Conventional Example 2”.

FIG. 11 is a perspective view of a shadow mask according to Embodiment 3 to which the present invention is applied, while the z-coordinate of the diagonal axis end of the perforated region 11 is set to be Z_{DP}=31.2 mm, which is the same as that of Conventional Example 2. An example corresponding to Embodiment 3 will be shown. Z_{XP}=17.4 mm, Z_{YP}=13.0 mm, and Z_{DP}=31.2 mm. The z-coordinate Z_{XP} of the x-axis end was set to be the same value as that of Conventional Example 2, and unlike Examples 1 and 2, Z_{XP}≠Z_{DP}. Because of this, the effect in the case where the short side of the perforated region 11 is not linear also can be confirmed simultaneously. The z-coordinate of an arbitrary point on the surface of the perforated region 11 is represented by the following Expression 9 with the x-coordinate and the y-coordinate of the arbitrary point being variables x and y. Expression 9 is obtained by replacing α with that obtained by adding the third term of a cosine series to the term of a cosine function in Expression 1.

$$z ( x , y ) = γ [ α {z}_{x 1} ( x ) + \{ 1 - α \} {z}_{x 2} ( x ) ] + {z}_{y 1} ( y ) , \\ α = \frac{1}{2} [ 1 + \{ 1.05 cos ( \frac{π}{{Y}_{P}} y ) - 0.05 cos ( 3 \frac{π}{{Y}_{P}} y ) \} ] , \\ γ = 1 + \frac{{z}_{yS} ( y ) - {z}_{y 1} ( y )}{{Z}_{XP}} , \\ {z}_{x 1} ( x ) = {ax}^{3} , a = \frac{{Z}_{XP}}{{X}_{P}^{3}} , \\ {z}_{x 2} ( x ) = b \{ 1 - cos ( \frac{π}{{X}_{P}} x ) \} , b = \frac{1}{2} {Z}_{XP} , \\ {z}_{y 1} ( y ) = {cy}^{3} , c = \frac{{Z}_{YP}}{{Y}_{P}^{3}} , \\ {z}_{yS} ( y ) = d \{ 1 - cos ( \frac{π}{{Y}_{P}} y ) \} , d = \frac{1}{2} ( {Z}_{DP} - {Z}_{XP} ) \qquad Expression 9 \text{:}$$

Furthermore, in the same way as in Example 2, the surface shape of the non-perforated region 12 was set to be a curved surface obtained by connecting regions among the x-axis end, the y-axis end, and the diagonal axis end with a smooth curved surface so that the radius of curvature in the x-axis direction passing through the x-axis end was 14 mm, the radius of curvature in the y-axis direction passing through the y-axis end was 10 mm, and the radius of curvature in the diagonal direction passing through the diagonal axis end was 15 mm, and the radius of curvature changed gradually in these regions. A calculation model of the shadow mask 10 for a color cathode-ray tube for a TV with a diagonal size of 68 cm based on Expression 9 was produced on a computer. This is assumed to be “Example 3”.

Table 3 shows the maximum values of the calculation results of the landing movement amounts regarding Conventional Example 1, Conventional Example 2, and Example 3 in the same way as in Table 2.

TABLE 3

| | Conventional | Conventional | |
|---|---|---|---|
| Irradiated position | Example 1 | Example 2 | Example 3 |
| (A) Center | 56% | 40% | 42% |
| (B) Upper or lower ⅔ | 50% | 41% | 11% |
| (C) Right or left ⅔ | 99% | 74% | 51% |
| (D) Right or left ⅓ | 99% | 67% | 55% |
| (E) Diagonal ⅔ | 78% | 59% | 42% |
| (F) Diagonal ⅓ | 100% | 68% | 56% |
| (G) Entire region | 79% | 59% | 53% |

As shown in Table 3, in Conventional Example, 2, the landing movement amounts in any of (A) to (G) are reduced compared with those of Conventional Example 1, as expected, by increasing Z_{DP}. Furthermore, in Example 3, the effect of the present invention is exhibited, and the landing movement amounts in (C) to (F) to be problems are reduced to a level smaller by 20% to 30% compared with that of Conventional Example 2. From this fact, it is understood that the color displacement caused by doming is sufficiently reduced even in the case where ZDP is different from that of Embodiments 1 and 2. Furthermore, it was confirmed that the short side of the perforated region 11 need not be linear.

Although the applicable field of the present invention is not particularly limited, the color displacement caused by the local increase in temperature of a shadow mask using an inexpensive iron material can be prevented, so that the present invention can be used widely as a color cathode-ray tube, etc. capable of performing a satisfactory color display at low cost.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color cathode-ray tube, comprising: a panel; a funnel connected to the panel; an electron gun provided in a neck of the funnel; and a substantially rectangular shadow mask provided so as to be opposed to an inner surface of the panel,
wherein the shadow mask includes a perforated region in which a plurality of electron beam passage apertures are formed, a non-perforated region provided on a periphery of the perforated region, in which the electron beam passage apertures are not formed, and a skirt portion bent to the electron gun side with respect to the non-perforated region, and
assuming that a center of the perforated region is an origin, an axis that passes through the origin and is parallel to a long side of the shadow mask is an x-axis, an axis that passes through the origin and is parallel to a short side of the shadow mask is a y-axis, and a normal to the shadow mask at the origin is a z-axis, curved surfaces on the x-axis and the y-axis in the perforated region are convex to the panel side, the perforated region has a curved surface that is convex to the panel side and a curved surface that is convex to the electron gun side on a periphery thereof, and the perforated region has a curved surface that is convex to the panel side and a curved surface that is convex to the electron gun side in a region surrounded by the periphery, the x-axis, and the y-axis.

2. The color cathode-ray tube according to claim 1, wherein a direction directed from the shadow mask to the electron gun is set to be a positive direction of the z-axis,
assuming that z-coordinates of two points on a surface of the perforated region, which have the same y-coordinate and x-coordinates of x1 and x2, are z1 and z2, respectively, and x1<x2, a relationship z1<z2 is satisfied, and assuming that z-coordinates of two points on the surface of the perforated region, which have the same x-coordinate and y-coordinates of y3 and y4, are z3 and z4, respectively, and y3<y4, a relationship z3<z4 is satisfied.

3. The color cathode-ray tube according to claim 1, wherein a z-coordinate of a point on a surface of the perforated region is, with an x-coordinate of the point being a variable x, represented by an m-order function of the variable x on the x-axis, represented by a cosine function of the variable x on a long side of the perforated region, and represented by a function including at least the m-order function of the variable x and the cosine function of the variable x in a region between the x-axis and the long side.

4. The color cathode-ray tube according to claim 1, wherein a z-coordinate of a point on a surface of the perforated region is, with a y-coordinate of the point being a variable y, represented by an n-order function of the variable y on the y-axis, represented by a cosine function of the variable y on a short side of the perforated region, and represented by a function including at least the n-order function of the variable y and the cosine function of the variable y in a region between the y-axis and the short side.

5. The color cathode-ray tube according to claim 1, wherein a z-coordinate of a point on a surface of the perforated region is, with an x-coordinate and a y-coordinate of the point being a variable x and a variable y, represented by an m-order function of the variable x on the x-axis, represented by an n-order function of the variable y on the y-axis, represented by a cosine function of the variable x on a long side of the perforated region, a cosine function of the variable y on a short side of the perforated region, and represented by a function including at least the m-order function of the variable x, the n-order function of the variable y, the cosine function of the variable x, and the cosine function of the variable y in a region surrounded by the x-axis, the y-axis, the long side, and the short side.

6. A color cathode-ray tube according to claim 1, wherein assuming that an x-coordinate of a point where a pair of short sides of the perforated region and the x-axis cross each other is ±X_{P}, a z-coordinate thereof is Z_{XP}, a y-coordinate of a point where a pair of long sides of the perforated region and the y-axis cross each other is ±Y_{P}, a z-coordinate thereof is Z_{YP}, and a z-coordinate of a point where a periphery of the perforated region and a diagonal axis of the perforated region cross each other is Z_{DP} (X_{P}, Y_{P}, Z_{XP}, Z_{YP}, Z_{DP}≠0), a z-coordinate of an arbitrary point on the surface of the perforated region is approximated by the following Expression 1 with an x-coordinate and a y-coordinate of the point being variables x and y
$$\begin{matrix}z ( x , y ) = γ [ α {z}_{x 1} ( x ) + \{ 1 - α \} {z}_{x 2} ( x ) ] + {z}_{y 1} ( y ) , \\ α = \frac{1}{2} \{ 1 + cos ( \frac{π}{{Y}_{P}} ) \} , γ = 1 + \frac{ {z}_{ yS} ( y ) - {z}_{y 1} ( y )}{{Z}_{XP}} , \\ {z}_{x 1} ( x ) = {ax}^{m} , a = \frac{{Z}_{XP}}{{X}_{P}^{m}} , m \geq 0 , \\ {z}_{x 2} ( x ) = b \{ 1 - cos ( \frac{π}{{X}_{P}} x ) \} , b = \frac{1}{2} {Z}_{XP} , \\ {z}_{y 1} ( y ) = {cy}^{n} , c = \frac{{Z}_{XP}}{{Y}_{P}^{n}} , n \geq 0 , \\ {z}_{yS} ( y ) = d \{ 1 - cos ( \frac{π}{{Y}_{P}} y ) \} , d = \frac{1}{2} ( {Z}_{DP} - {Z}_{XP} ) .\end{matrix} \qquad Expression 1 \text{:}$$

7. The color cathode-ray tube according to claim 6, wherein in the Expression 1, Zₓ₂(x) is represented by
$${z}_{x 2} ( x ) = b [ 1 - {\sum }_{λ = 1}^{h} \{ R {1}_{λ} cos ( λ \frac{π}{{X}_{P}} x ) \} + C 1 ]$$
$$( R {1}_{λ} \text{:} Constant with respect to each λ . C 1 \text{:} Constant )$$
where a term of a cosine function is replaced with a cosine series.

8. The color cathode-ray tube according to claim 6, wherein in the Expression 1, α is represented by
$$α = \frac{1}{2} [ 1 + {\sum }_{μ = 1}^{i} \{ R {2}_{μ} cos ( μ \frac{π}{{Y}_{P}} y ) \} + C 2 ]$$
$$( R {2}_{μ} \text{:} Constant with respect to each μ . C 2 \text{:} Constant )$$
where a term of a cosine function is replaced with a cosine series.

9. The color cathode-ray tube according to claim 6, wherein in the Expression 1, Z_{yS}(y) is represented by
$${z}_{yS} ( y ) = d [ 1 - {\sum }_{ν = 1}^{j} \{ R {3}_{ν} cos ( ν \frac{π}{{Y}_{P}} y ) \} + C 3 ]$$
$$( R {3}_{ν} \text{:} Constant with respect to each ν . C 3 \text{:} Constant )$$
where a term of a cosine function is replaced with a cosine series.

10. The color cathode-ray tube according to claim 1, wherein the non-perforated region connects the perforated region to the skirt portion with a smooth curve in a cross-section that is parallel to the z-axis and vertical to a plane of the skirt portion, and a radius of curvature of the non-perforated region is maximum in a diagonal direction passing through a diagonal axis end of the shadow mask.

11. The color cathode-ray tube according to claim 1, wherein the non-perforated region has a linear portion in a cross-section that is parallel to the z-axis and is vertical to a plane of the skirt portion.

12. The color cathode-ray tube according to claim 1, wherein the shadow mask is made of a material containing Fe as a main component.

13. The color cathode-ray tube according to claim 1, wherein the shadow mask has an electron reflective coating film on a surface thereof opposed to the electron gun.

14. The color cathode-ray tube according to claim 1, wherein the perforated region has a plurality of tie-bands with a longitudinal direction thereof being the y-axis direction, and unevenness is formed by half-etching on surfaces of the plurality of tie-bands.
